(19) United States
(12) Patent Application Publication
(10) Pub. No.: US 2024/0342662 A1
(43) Pub. Date: Oct. 17, 2024

(54) CROSS-LINKED MIXED-MATRIX MEMBRANES, COMPOSITION AND METHOD

(71) Applicants: The Regents of The University of Colorado, a body corporate, Denver, CO (US); TotalEnergies OneTech, Courbevoie (FR)

(72) Inventors: Douglas L. GIN, Denver, CO (US); Collin A. DUNN, Louisville, CO (US); Richard D. NOBLE, Denver, CO (US); Haïfa BEN HASSINE, Pau (FR)

(21) Appl. No.: 18/292,758

(22) PCT Filed: Jul. 29, 2021
(86) PCT No.: PCT/IB2021/000533

§ 371 Date: Jan. 26, 2024

(51) Int. Cl. B01D 69/14; B01D 53/22; B01D 67/00; B01D 71/02; B01D 71/40

(52) U.S. Cl. CPC B01D 69/1411; B01D 53/228; B01D 67/00793; B01D 71/0281; B01D 71/40; B01D 2257/504; B01D 2323/30

(57) ABSTRACT

The invention relates to a composition comprising: at least one porous solid additive having a charged surface; an IL; a polymerizable IL; and a cross-linker; wherein the cross-linker wherein the cross-linker has a high affinity to CO₂ over other light gas and comprises at least two polymerizable groups configured to react, in a radical polymerization reaction, with the polymerizable ionic liquid, said polymerizable groups preferably containing double bond.

### FIELD OF THE INVENTION

The present invention relates to the field of gas separation using membranes. In particular, the invention relates to the field of mixed-matrix membranes. This invention provides a new mixed-matrix membrane, a composition for the preparation of said mixed-matrix membrane and a method of manufacturing a mixed-matrix membrane.

### DESCRIPTION OF RELATED ART

The global demand for natural gas is growing. In 2019, the United States alone consumed 846.6 billion m³ of natural gas, i.e. an increase of 3.3% in 2019 and 37% since 2009. The USA are the world's largest consumers with 21.5% of world consumption, far ahead of Russia (11.3%) and China (7.8%). (BP Statistical Review of World Energy 2020-69th edition and Statistical Review of world energy—June 2020).

Natural gas is primarily composed of methane (CH₄) but can comprise carbon dioxide (CO₂) which is detrimental to gas quality, as it depresses the heating value of natural gas, and forms carbonic acid in the presence of water, which corrodes pipeline equipment. Common methods for removing CO₂ include cryogenic distillation, pressure or temperature swing adsorption, amine scrubbing, and membrane separation. Currently, amine scrubbing is the dominant technology, while membranes account for only 5% of the separations market. However, scrubbing requires a significant energy cost to strip CO₂ from the amine salt and poses an environmental risk.

Compared to energy-intensive CO₂ separation methods such as amine scrubbing or adsorption processes, membrane-based separations are generally regarded as being more environmentally friendly, having a smaller footprint, and requiring lower capital and operating costs. A promising class of membrane materials for CO₂/CH₄ separations are mixed-matrix membranes (MMMs) that comprise a porous solid (such as a zeolite) in a polymer matrix.

Research in membrane gas separation, and in particular in MMMs, is focused on the development of membranes with high permeability and selectivity. Conventional MMMs are prepared from an addition of porous inorganic filler to polymer matrix. Indeed, MMMs were proposed as a strategy to utilize the excellent separation properties of zeolites into a more easily processable material. For example, MMM preparation can consist of incorporating a zeolite into a rubbery polymer of poly(dimethylsiloxane).

However, it was rapidly determined that the performance of MMMs was limited by poor interfacial adhesion between the zeolite particles and the polymer matrix. Because the resulting interfacial void spaces are non-selective and provide a low-resistance route for gas transport, the CO₂/CH₄ separation potential of the first MMMs was severely limited. One possible solution to limit this effect is to produce MMMs with high zeolite loadings. These MMMs displayed significant selectivity enhancements. However, the high zeolite content reduced mechanical stability and produced brittle MMMs, which are unsuitable for the high-pressure differentials present in natural gas separations processes.

New MMMs have been produced by the in situ radical cross-linking of a mixture consisting of a polymerized ionic liquid (PIL), a free ionic liquid (IL), and a zeolite. Ionic liquids (ILs) are organic molten salts that have a melting point below 100° C., preferably a melting point at room temperature. ILs exhibit many properties that distinguish them from other liquids, including negligible vapor pressures, high thermal stability, and high solubility for a wide range of inorganic and organic compounds. Polymerized ionic liquids (PILs), are polymers with charged repeat units that are based on ILs (e.g., made from IL monomers). PILs are typically solid materials and thus have lower ion and gas diffusivity than ILs but similar gas solubility values and better mechanical stability. Such MMMs have shown exceptional performance in separating CO₂ from CH₄ in low-pressure, single-gas testing (Bara et al. 2008. Improving CO₂ permeability in polymerized room-temperature IL gas separation membranes through the formation of a solid composite with a room-temperature IL. Polym. Adv. Technol. 2008; 19: 1415-1420). In particular it has been shown that the use of an IL both increase the permeability of the membrane and facilitate interaction between the PIL (polymer) and zeolite (Hudiono et al. 2010. A three-component mixed-matrix membrane with enhanced CO₂ separation properties based on zeolites and IL materials. Journal of Membrane Science 350 (2010) 117-123).

Advantageously, the preparation of those MMMs involved radical polymerization via cross-linking, which is most convenient for industrial production and compatible with a large variety of functional groups or chain length compared to condensation polymerization, cationic polymerization, or anionic polymerization.

Further studies shown that the presence of ILs in the polymer matrix will plasticize the PIL. Thus, addition of IL into the polymer matrix increased the permeability of the studied composite membranes. The IL disrupts inter-chain packing and the PIL matrix becomes rubberier. The polymer chains are therefore able to move more freely and have better interfacial interaction with the surface of the zeolite particles. This study shows that the presence of IL in the 3-component MMMs improves the gas separation performance of the membranes by enhancing the adhesion interaction between the polymer matrix and zeolite surface (Hudiono et al. 2011. Novel mixed matrix membranes based on polymerizable room-temperature ILs and SAPO-34 particles to improve CO₂ separation. Journal of Membrane Science 370 (2011) 141-148).

Moreover, it has been proposed to optimize the underlying factors responsible for reducing interfacial void space and improving the CO₂/CH₄ separation performance of PIL-IL-zeolite MMMs (Singh et al. 2016. Determination and optimization of factors affecting CO₂/CH₄ separation performance in poly(IL)-IL-zeolite mixed-matrix membranes. Journal of Membrane Science 509 (2016) 149-155). To control the interfaces between the three components in these MMMs, zeolite loading, zeolite type, PIL structure, and amount of polymer cross-linking have been varied. The effect of these variations on the CO₂/CH₄ separation performance has been studied and an optimized MMM material with improved CO₂/CH₄ selectivity and permeability was identified. Additionally, the mechanical stability of these MMMs has been demonstrated and these MMMs, based on a PIL-IL platform, has been recently processed in 100-nm-thick active layers. The combination of high CO₂/CH₄ separation performance, mechanical stability, and potential process ability is a significant breakthrough in materials for natural gas separations and make these MMMs attractive candidates for future applications to industrial CO₂/CH₄ separation.

However, when these MMMs were tested under mixed-gas, high-pressure, and/or high-temperature conditions, their CO₂/CH₄ selectivity's decreased dramatically. Additionally, when applied as thin films, these MMMs demonstrate severely reduced permeability. Finally, additional zeolites with high degrees of CO₂ permeability and CO₂/CH₄ selectivity need to be identified that will work in these MMMs formulations.

Hence, there is a need for new methods and optimized composition mixtures to generate cross-linked MMMs with better CO₂/CH₄ separation selectivity and CO₂ permeability when used under mixed-gas, high-pressure, and/or high-temperature operating conditions.

### Technical Problem

The invention aims to overcome the disadvantages of the prior art. One of the aims of this invention is to develop methods for optimizing the composition of these mixtures to generate MMMs with better CO₂/CH₄ separation selectivity and higher CO₂ permeability when used under mixed gas, high-pressure, and/or high-temperature operating conditions, and also an MMMs less prone to the phenomena of plasticization and swelling.

In particular, the invention proposes a new composition to generate MMMs with better selectivity and permeability in particular conditions as mixed-gas, high-temperature, and high-pressure. Also, the present disclosure proposes new MMMs and method of production thereof.

### SUMMARY OF THE INVENTION

The following sets forth a simplified summary of selected aspects, embodiments and examples of the present invention for the purpose of providing a basic understanding of the invention. However, the summary does not constitute an extensive overview of all the aspects, embodiments and examples of the invention. The sole purpose of the summary is to present selected aspects, embodiments and examples of the invention in a concise form as an introduction to the more detailed description of the aspects, embodiments and examples of the invention that follow the summary.

Hence, according to an aspect of the present invention, it is provided a composition comprising:
at least one porous solid additive having a charged surface;
an ionic liquid;
a polymerizable ionic liquid, such as a ionic liquid monomer; and
a cross-linker;
   wherein the cross-linker has a high affinity to CO₂ over other light gas and comprises at least two polymerizable groups configured to react, in a radical polymerization reaction, with the polymerizable ionic liquid, said polymerizable groups preferably containing a double bond.

Whereas persons skilled in the art already proposed an increase of the cross-linker amount in the mixed matrix membranes conducing to MMMs showing a dramatic CO₂/CH₄ selectivity's decrease at high pressure. The cross-linker modification allows an increase in the selectivity of the MMMs in particular when being operated at high pressure.

According to other optional features of composition, it can optionally include one or more of the following characteristics alone or in combination:
the cross-linker comprises at least one functional group having high affinity to CO₂.
the at-least one group having high affinity to CO₂ comprise at least a functional group selected from: phosphonium; ammonium; imidazolium; and/or pyridinium.
the cross-linker is selected from:

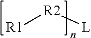

Wherein
R1 comprises at least one radically polymerizable double bond group;
R2 comprises at least a functional group having a high affinity for CO₂ over other light gases
L refers to any carbon-containing group capable of being a central point for a functional group having a high affinity for CO₂;
n is an integer starting from 1, preferably from 2.
The at-least one group having high affinity to CO₂ comprise at least an imidazolium functional group.
Preferably, the cross-linker being preferably selected from:

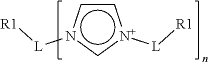

Wherein
   R1 is independently selected from at least one radically polymerizable double bond group
   L is independently selected from an organyl group, a hydrocarbyl group; an alkyl group; an aliphatic group; a cycloalkyl group; an alkenyl group; an alkynyl group; an aromatic group; an aryl group; a heterocyclyl group; a cycloheteryl group; a heteroaryl group; an arylheteryl group; an organoheteryl group; an aralkyl group; a heteroaralkyl group; a halide; substituted or not;
   n is an integer which can be selected from 1 to 10.
The at-least one group having high affinity to CO₂ comprise at least an ammonium functional group.
Preferably, the cross-linker being preferably selected from: R1-L-(AMO-L-R1)n
Wherein
   R1 is independently selected from at least one radically polymerizable double bond group
   L is independently selected from an organyl group, a hydrocarbyl group; an alkyl group; an aliphatic group; a cycloalkyl group; an alkenyl group; an alkynyl group; an aromatic group; an aryl group; a heterocyclyl group; a cycloheteryl group; a heteroaryl group; an arylheteryl group; an organoheteryl group; an aralkyl group; a heteroaralkyl group; a halide; substituted or not;
   AMO is independently selected from N, NR, NR₂, wherein R may be a hydrogen or independently selected from an organyl group, a hydrocarbyl group; an alkyl group; an aliphatic group; a cycloalkyl group; an alkenyl group; an alkynyl group; an aromatic group; an aryl group; a heterocyclyl group; a cycloheteryl group; a heteroaryl group; an arylheteryl group; an organoheteryl group; an aralkyl group; a heteroaralkyl group; a halide; substituted or not;
   n is an integer which can be selected from 1 to 10.
The at least one functional group having high affinity to CO₂ comprises of at least an imidazolium functional group and at least one ammonium functional group.
The at-least one group having high affinity to CO₂ comprise at least a phosphonium functional group.
Preferably, the cross-linker being preferably selected from: R1-L-(PHOS-L-R1)n
Wherein
   R1 is independently selected from at least one radically polymerizable double-bond group
   L is independently selected from an organyl group, a hydrocarbyl group; an alkyl group; an aliphatic group; a cycloalkyl group; an alkenyl group; an alkynyl group; an aromatic group; an aryl group; a heterocyclyl group; a cycloheteryl group; a heteroaryl group; an arylheteryl group; an organoheteryl group; an aralkyl group; a heteroaralkyl group; a halide; substituted or not;
   PHOS is independently selected from P, PR, PR₂ wherein R may be a hydrogen or independently selected from an organyl group, a hydrocarbyl group; an alkyl group; an aliphatic group; a cycloalkyl group; an alkenyl group; an alkynyl group; an aromatic group; an aryl group; a heterocyclyl group; a cycloheteryl group; a heteroaryl group; an arylheteryl group; an organoheteryl group; an aralkyl group; a heteroaralkyl group; a halide; substituted or not; and
   n is an integer which can be selected from 1 to 10.
The at-least one group having high affinity to CO₂ comprise at least a pyridinium functional group.
Preferably, the cross-linker being preferably selected from: R1-L-(PYR-L-R1)n
Wherein
   R1 is independently selected from at least one radically polymerizable double bond group
   L is independently selected from an organyl group, a hydrocarbyl group; an alkyl group; an aliphatic group; a cycloalkyl group; an alkenyl group; an alkynyl group; an aromatic group; an aryl group; a heterocyclyl group; a cycloheteryl group; a heteroaryl group; an arylheteryl group; an organoheteryl group; an aralkyl group; a heteroaralkyl group; a halide; substituted or not;
   PYR is independently selected from C₅H₅N, R—C₅H₄N, R₂C₅H₃N, R₃C₅H₂N, R₄—C₅HN, R₅C₅N, wherein R may be a hydrogen or independently selected from an organyl group, a hydrocarbyl group; an alkyl group; an aliphatic group; a cycloalkyl group; an alkenyl group; an alkynyl group; an aromatic group; an aryl group; a heterocyclyl group; a cycloheteryl group; a heteroaryl group; an arylheteryl group; an organoheteryl group; an aralkyl group; a heteroaralkyl group; a halide; substituted or not;
   n is an integer which can be selected from 1 to 10.
the cross-linker further comprises at least one polar group selected from: ether, ethylene glycol, fluoroalkyl, aromatic ring, or nitrile.
the cross-linker comprises at least a region of overlapping p orbitals allowing a delocalization of π electrons across all the adjacent p orbitals.
the cross-linker comprises two radically polymerizable double bonds groups, three radically polymerizable double bonds groups or four radically polymerizable double bonds groups.
the at-least one porous solid additive is a nanoporous solid additive or a microporous solid additive.
the at-least one porous solid additive is selected from zeolites, metal peroxides, zeolitic imidazolate frameworks and metal organic frameworks. Preferably, the at-least one porous solid additive is selected from:
   Zeolites: Zeolites A, ZSM-5, Zeolite-13X, Zeolite-KY, Silicalite-1, SSZ-13, SAPO-34,
   MCM-41, MCM-48, SBA-11, SBA-12, SBA-15, mesoporous ZSM-5, activated carbon, TiO2, MgO; and/or
   MIL-96, MIL-100, MOF-5, MOF-177, ZIF-7, ZIF-8, Cu-TPA, Cu₃(BTC)₂, Cu-BPY-HFS.
More preferably the at-least one porous solid comprises a zeolite.
the ionic liquid is an organic salt that displays liquid properties at least a temperature comprised between 0° C. and 100° C.
the ionic liquid comprises at least a functional group selected from: phosphonium; ammonium; imidazolium; and/or pyridinium.
the ionic liquid is a cation associated with an anion selected from the group consisting of chloride, acetate, trifluoromethylacetate (TfA⁻), nitrate, dicyanamide, Tf₂N⁻, BF₄⁻, N(CN)₂⁻, PF₆⁻, C(CN)₃⁻, B(CN)₄⁻, N(SO₂F)₂⁻, TfO⁻, SbF₆⁻, dicyanamide, halide, and sulfonate.
the polymerizable ionic liquid comprises one polymerizable group configured to react in a radical polymerization reaction with the polymerizable group of another polymerizable ionic liquid to form a polymer and at least one group having high affinity to CO₂ over other light gas, preferably said at least one group having high affinity to CO₂ comprises phosphonium; ammonium; imidazolium; and/or pyridinium.

According to another aspect, the invention relates to a mixed-matrix membrane formed from a composition according to the invention, including any preferred or optional embodiment.

In particular it relates to a MMM comprising:
at least one porous solid additive having a charged surface;
an ionic liquid; and
a polymerized matrix comprising an ionic liquid polymer covalently linked with a crosslinker;
wherein the cross linker has a high affinity to CO₂ over other light gas and the ionic liquid polymer is covalently linked with the crosslinker through a polymerizable group of the cross linker configured to react, in a radical polymerization reaction, with the ionic liquid polymer, said polymerizable groups preferably containing double bond.

According to another aspect, the invention relates to the use of a mixed-matrix membrane of the invention for example formed from a composition according to the invention, including any preferred or optional embodiment.

In particular, it relates to the use of a mixed-matrix membrane of the invention for gas separation, preferably CO₂ separation.

In particular, it relates to the use of a mixed-matrix membrane of the invention for CO₂ separation, in a mixed gas, at a pressure higher than 40 bars, preferably higher than 50 bars.

In particular, it relates to the use of a mixed-matrix membrane of the invention for CO₂ separation, in a mixed gas, at a temperature higher than 50° C., preferably higher than 60° C.

More preferably, it relates to the use of a mixed-matrix membrane of the invention for CO₂ separation, in a mixed gas, at a pressure higher than 50 bars and a temperature higher than 60° C.

According to another aspect, the invention relates to a method of manufacturing a mixed-matrix membrane of the invention for example from a composition according to the invention, including any preferred or optional embodiment.

In particular, it relates to a method of manufacturing a mixed-matrix membrane comprising a living chain-addition polymerization step based on a polymerizable ionic liquid and a cross-linker having a high affinity for CO₂ and at least two polymerizable groups configured to react, in a radical polymerization reaction, with the polymerizable ionic liquid, said polymerizable groups preferably containing a double bond.

### DETAILED DESCRIPTION

A description of example embodiments of the invention follows.

In the following description, “polymer” means either a copolymer (of the statistical, gradient, block, alternating type) or a homopolymer.

By “copolymer” is meant a polymer comprising several different or identical monomer units.

The term “oligomer” and similar terms as dimers, trimers, or heavy oligomers refer to oligomerization products containing, 2, 3, or more units derived from the monomer, respectively. The unit may be the same or different.

The term “monomer” as used refers to a molecule that can undergo polymerization.

The term “polymerization” as used refers to the chemical method of transforming a monomer or a mixture of monomers into a polymer of predefined architecture (block, gradient, statistical . . . ), a chemical reaction in which two or more molecules combine to form larger molecules that contain repeating structural units.

The expression “ring-opening metathesis polymerization” (ROMP) is a variant of the olefin metathesis reaction. The reaction uses strained cyclic olefins to produce monodisperse polymers and co-polymers of predictable chain length.

The expression “ionic liquid” (i.e., “IL”) as used herein can refer to a room-temperature molten salt that is comprised of cations and anions and that is liquid at 25° C. An IL according to the invention can be produced by melting a salt, and when so produced consists solely of ions. An IL may be formed from a homogeneous substance comprising one species of cation and one species of anion, or it can be composed of more than one species of cation and/or more than one species of anion. Thus, an IL may be composed of more than one species of cation and one species of anion. An IL may further be composed of one species of cation, and one or more species of anion. Still further, an IL may be composed of more than one species of cation and more than one species of anion. ILs are most widely known as solvents. IL refers to small molecule like a single molecule or single unit. Preferably the IL is liquid at room temperature or over room temperature. IL may also be a non-polymerizable IL such as non-polymerizable room-temperature IL.

The expression “polymerizable ionic liquid” (i.e., “polymerizable IL” or “IL monomer”), refers to monomer or oligomer, preferably monomer, polymerizable at room temperature, preferably by radical polymerization. Such a polymerizable IL refers to an IL in which the cation or anion has a polymerizable group.

The expression “ionic character” refers to a molecule that can be ionizable or that can carry a positive or negative electric charge as a result of having lost or gained one or more electrons.

The term “charged” refers to a molecule or a mineral with positive and/or negative charges at different locations within that molecule or mineral.

As used herein, the term “cross-linker” refers to a molecule that can form a chemical link between two molecules, in a preferred way between two polymers or oligomers. These links can be in the form of covalent bonds.

The term “moiety” refers to a specific segment or functional group of a molecule. Chemical moieties are often recognized chemical entities embedded in or appended to a molecule.

The term “unsaturated” as used herein, means that a moiety or a molecule has one or more units of unsaturation.

The term “saturated” as used herein, means that a moiety or a molecule does not have one or more units of unsaturation.

The term “backbone” refers to the main chain of a polymer or copolymer or oligomer of the present invention.

The term “selectivity” refers to a specificity feature with which the permeate is retained by the membrane. The selective permeability of a membrane means within the meaning of the present application that the membrane may control the entry and exit of molecules or ions between two media separated by the membrane.

The term “permeability” is a characteristic of the membrane which allows it to be penetrated, crossed, or traveled by molecules or ions, it is the ability to let itself be crossed by a fluid.

The term “zeolite” can refer to any of the natural or synthesized or hydrated silicates or aluminosilicates which are formed of crystal structures mainly containing silicon, aluminum, oxygen, eventually phosphorous and metals, including titanium, tin, zinc.

The term “porous” can refer to a material having pore space, pore being as small interstices or opening admitting passage of molecules. A porous material, in particular a porous solid, may be mesoporous or microporous. According to IUPAC (International Union of Pure and Applied Chemistry), microporous corresponds to a size pore less than 2 nm (type zeolite or aluminophosphate), and mesoporous (silicas, alumina, carbons, metal oxides) corresponds to a size pore between 2 and 50 nm; size corresponding to the diameter.

The term “plasticization” refers generally to the softening or swelling of the polymer matrix by penetrant gases can be attributed to the swelling stresses on the polymer network. It is well known that sorption of carbon dioxide in glassy polymers can facilitate the local segmental organization with a reduction in the permselectivity and substantially affect membrane morphological performance. Hence, plasticization is a phenomenon that most frequently encountered in polymer-gas systems for commercial CO₂/CH₄ separation applications where the membranes are exposed to high CO₂ concentration in the feed stream.

The expression “thin-film composite membrane” refers to the membrane thickness itself. Preferably the thickness of the membrane is thinner than current mixed-matrix membrane. For example, the thickness of the mixed-matrix membrane is comprised between 0.05 μm and 50 μm, preferably, below 5 μm, more preferably below 2 μm.

When introducing elements of various embodiments of the present disclosure, the articles “a” “an” and “the” are intended to mean that there are one or more of the elements. The terms “comprising,” “including,” and “having” are intended to be inclusive and mean that there may be additional elements other than the listed elements.

Additionally, it should be understood that references to “one embodiment” or “an embodiment” of the present disclosure are not intended to be interpreted as excluding the existence of additional embodiments that also incorporate the recited features.

In the rest of the description, the same references are used to designate the same elements.

As explain above current MMMs have reduced CO₂/CH₄ separation selectivity and CO₂ permeability when they are used under mixed gas, high-pressure, and/or high-temperature operating conditions.

Moreover, under higher-pressure, higher-temperature gas testing conditions there is a plasticization and swelling of the organic (PIL+IL) matrix around the zeolite particles. This leads to delamination of the PIL matrix from the selective zeolite particles and formation of microscopic gas defects around them, resulting in lower selectivity.

Additionally, higher operating temperatures impede the adsorption of CO₂ onto the surface of the zeolite particles, further reducing the selectivity of these membranes at elevated temperatures. For improving the permeability of a thin film composite membrane, it may be possible to make the active layer thinner, and faster roll-to-roll casting may allow for better film homogeneity at a larger scale.

The inventors have developed a new composition and a new method for optimizing the composition of these (polymerizable IL/cross-linking agent/free IL/zeolite) mixtures to generate cross-linked MMMs with better CO₂/CH₄ separation selectivity and CO₂ permeability when used under mixed gas, high-pressure, and/or high-temperature operating conditions.

The invention will be described thereafter in the framework of separation of gas, in particular CO₂/CH₄ separation, it should be considered that the invention is not limited to CO₂/CH₄ and gas separation. The composition of the invention could be implemented with various fluids or plasmas and in numerous different technical fields as filtration, purification, gas production, etc.

According to a first aspect, the invention relates to a composition for the synthesis of a MMM.

A very large variety of mixed matrix membranes have been proposed in the literature and are currently under development. The present invention relates to a composition for MMM preparation comprising:
at least one porous solid additive having a charged surface;
an IL;
a polymerizable IL (i.e., an IL monomer); and
a cross-linker.

Advantageously, as it will be described, the cross-linker comprises:
at least two polymerizable groups configured to react, in a radical polymerization reaction, with the IL monomer, said polymerizable groups preferably containing a double bond;
at least one group having high affinity to CO₂, in particular, a higher affinity for CO₂ relative to other light gases.

We will describe below the different constituents of this composition.

### One Porous Solid Additive

A composition according to the invention comprises at least one porous solid additive having a charged surface.

The presence of charged surface may allow preventing crystallization of the organic phase and increase the mechanical and separation performance of the membrane.

Most of solid additive are porous and are used as molecular sieves (zeolites, nanometric articles or even carbon molecular sieves). These molecular sieves have a very much higher permeability and selectivity than organic membranes and have a very narrow pore size distribution.

The growth of these polycrystalline solids can take place on inorganic supports such as oxidized copper structures or porous alumina.

These sieves work at the molecular level. It is this porosity scale (close in size to that of the kinetic diameters of carbon dioxide, nitrogen and methane) that makes MMMs so attractive for gas separation. Several families of molecular sieves exist but zeolites and carbon molecular sieves CMS (“Carbon Molecular Sieves”) are the most popular, as also MOFs, ZIFs, porous and non-porous silicas, and finally metal oxides. The selection of charges is always made according to the size of the porosity of these (by comparing with the kinetic diameters of the gases to be separated), but also according to their polarity, which also determines their ability to interact with the gases. For example, a polar material will be chosen to interact with CO₂.

Zeolites are microporous crystals formed from aluminosilicate and are more or less polar depending on the Si/Al ratio.

Zeolites, compared to polymer, have high selectivity. Nevertheless, they present two types of defects in MMMs: interfacial voids (increasing permeability and decreasing selectivity) and the stiffening of the polymer chains (decreasing permeability due to the loss of mobility and increasing selectivity).

In order to overcome these defects, surface charges can be integrated into the porous solid.

Advantageously, the at-least one porous solid additive has a charged surface.

The at-least one porous solid additive having a charged surface may preferably be porous, either microporous or nanoporous. More precisely, the at-least one porous solid may be either mesoporous with size pores (diameter) between 2 and 50 nm, or, microporous with size pores less than 2 nm.

In particular, the porous solid additive can be a nanoporous solid additive or a microporous solid additive.

For example, the porous solid additive can be selected from zeolites, metal peroxides, zeolitic imidazolate frameworks and metal organic frameworks.

Preferably, the at-least one porous solid may comprise a zeolite. According to the invention the at-least one porous solid may be selected from zeolites, metal peroxides, zeolitic imidazolate frameworks and metal organic.

More preferably, when the at-least one porous solid comprises zeolite, said zeolite comprises a silicoaluminophosphate, an aluminosilicate, a silicate, or an alkali metal aluminosilicate.

Zeolite may also comprise Ge, Ga, Ti, V, Fe, or B.

Preferred zeolites can be selected from: Zeolites-A, ZSM-5, Eolite-13X, Zeolite-KY, Silicalite-1, SSZ-13, and SAPO-34.

Preferred mesoporous materials can be selected from: MCM-41, MCM-48, SBA-11, SBA-12, SBA-15, mesoposrous ZSM-5, activated carbon, TiO₂, and MgO.

Zeolite can also comprise framework structure as MOFs. MOFs are compounds having metal ions or clusters coordinated to organic molecules to form one-, two-, or three-dimensional structures that can be porous. By themselves, MOFs have been demonstrated to have very high gas sorption capacities, which suggest that gases generally will diffuse readily through MOFs if incorporated into a membrane. However, it has been discovered that MOFs attached to a polymeric membrane via a covalent or hydrogen bond or van der Waals interaction create membranes that improve on the permeability and selectivity parameters by virtue of being void-free or substantially void-free, where either no voids or voids of less than several Angstroms are present at the interface of the polymers and the MOFs. According to one embodiment, MOF may be chemical modified to use a linker that has a pendant functional group for post-synthesis modification. In some embodiments, the MOFs are zeolitic imidazolate frameworks (ZIFs). ZIFs are a subclass or species of MOFs and have attractive properties such as high specific surface area, high stability, and chemically flexible framework.

In a further aspect, the imidazolate structures or derivatives can be further functionalized to impart functional groups that line the cages and channel, and particularly the pores to obtain a desired structure or pore size.

In general, dimers, trimers, tetramers or polyhedral chains can be incorporated into MOFs as linkers that can easily be modified with numerous organic groups.

Preferred metal organic frameworks can be selected from: MIL-96, MIL-100, MOF-5, MOF-177, ZIF-7, ZIF-8, Cu-TPA, Cu₃(BTC)₂, Cu-(hfipbb)(H2hfipbb)0.5, IRMOF-1, IRMOF-3, HKUST-1, MMOF, ZIF-22, ZIF-90, MIL-53, Co₃(HCOO)₆ and Cu-BPY-HFS.

### Ionic Liquid

A composition according to the invention may also comprise an ionic liquid (IL).

Preferably, the IL is an organic salt that displays liquid properties at least at temperatures between 0° C. and 100° C.

ILs have very good thermophysical properties (almost zero saturating vapor pressure, thermal stability, adaptable viscosity and miscibility) and solubility. In fact, IL solubilize a very large number of organic compounds and metal ions.

ILs, also called liquid electrolytes, ionic melts, ionic fluids, liquid salts, or ionic glasses, generally include salts that form stable liquids. These materials consist of large organic bulky asymmetric cations, such as quaternary ammonium, imidazolium, pyridinium, and phosphonium ions, and small symmetric inorganic anions, including Cl, Br, I, BF₄, PF₆, Tf₂N, or organic anions, including RCO₂.

Advantageously, the CO₂ is very soluble in these ILs, which promotes gas separation.

The ionic character allows preventing the plasticization effect in the mixed-matrix membranes.

The ILs can impregnate the pores of a porous material, which allows a great variability of structures depending on the nature of the IL chosen for the impregnation and that of the porous material.

Preferably, ILs are small molecules like a single molecule. A single molecule may have several subunits.

The cation of the ILs are preferably selected from: imidazolium, pyridinium, quaternary ammonium, triazolium, azole alkane, phosphonium, sulfonium pyrazolium, pyrrolidinium, piperidinium, morpholinium, cholinium, or mixture thereof; and the anion of the ILs are preferably selected from: tetrafluroborate, hexafluorophosphate, triflate, bis(triflimide), dicyanamide, tetracyanoborate, or mixtures thereof.

More preferably, the IL cation comprises at least a functional group selected from: phosphonium, quaternary ammonium, imidazolium; pyridinium, pyrrolidinium, piperidinium, morpholinium, azole alkane, sulfonium and triazolium.

The IL anion can be selected from the group consisting of chloride, acetate, trifluoromethylacetate (TfA⁻), nitrate, dicyanamide, bis(trifluoromethane)-sulfonimide (Tf₂N⁻), tetrafluoroborate (BF₄⁻), N(CN)₂⁻, PF₆⁻, C(CN)₃⁻, B(CN)₄⁻, N(SO₂F)₂⁻, TfO⁻, SbF₆⁻, dicyanamide, halide, sulfonate, or mixtures thereof.

In order to improve gas transport properties of an IL, the IL may comprise a cationic substitution with adding an alkyl group or polar group, as ether group, methyl, ethyl, butyl, styrene, or ethylene glycol. For example, such an IL may be ethyl methyl imidazolium Tf₂N, butyl methyl imidazolium Tf₂N, poly(methyl imidazolium base styrene) Tf₂N, poly(cyano imidazolium base styrene), poly(cyanoimidazolium base styrene) Tf₂N, poly ethylene glycol imidazolium base styrene Tf₂N.

IL may also comprise a change of anion in order to improve interactions with CO₂ as ethyl methylimidazolium or a functionalization.

### Polymerizable Ionic Liquid (i.e., IL Monomer)

The composition according to the invention may also comprise a polymerizable IL, such as a IL monomer.

The polymerizable IL may comprise repeated units for example less than 3 repeated units.

Preferably, the polymerizable IL may comprise at least one polymerizable group configured to react in a radical polymerization reaction with the polymerizable group of another polymerizable IL to form a polymer. The polymerizable IL may also react with the at-least one group having high affinity to CO₂ over other light gas, in particular, a higher affinity to CO₂ than to other light gases.

Preferably said at least one group having high affinity to CO₂ comprises phosphonium; ammonium; imidazolium; and/or pyridinium.

Preferably, polymerizable ILs are derived from ILs with polymerizable functional groups. A polymerizable function may be styrene, acrylate or vinyl.

Preferably, PILs (polymerized ILs) refer to polymeric compounds that feature an IL species in each monomer repeating unit, connecting through a polymeric backbone, which are obtained by polymerization of ILs having polymerizable groups. The major advantages for such polymeric forms of ILs are enhanced stability, flexibility, and durability.

Polymerizable ILs as a source of PILs can be available by incorporating polymerizable groups either at anionic or at cationic site in the IL structure and which gave the corresponding PILs by radical polymerization. For example, polymerizable anions are ionically exchanged with some anions of general ILs to produce the polymerizable ILs.

The composition can comprise at least two polymerizable IL to form a block copolymer in the MMM. Such a MMM comprising a cross-linker according to the invention and a block copolymer constituted from at least two polymerizable ILs will combine the benefits of three or more groups having high affinity to CO₂.

### Cross-Linker

In particular, according to one embodiment of the present invention, the composition may comprise a cross-linker.

The cross-linker has preferably a high CO₂ solubility, and more preferably a solubility selectivity to CO₂ over other light gases.

In particular, a cross-linker used in a composition of the invention allows combining polymerizable IL.

In particular, a cross-linker according to the invention can be a cross-linker of formula I:

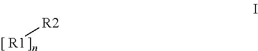

Wherein
R1 comprises at least one radically polymerizable double bond group;
R2 comprises at least a functional group having a high affinity for CO₂, for example the functional group has a higher affinity for CO₂ than for other light gases;
n is an integer starting from 2.

### High Affinity for CO₂

According to the present invention, the cross-linker used in the present invention have a high affinity for CO₂. In a particular embodiment, it will comprise at least one group having high affinity to CO₂ over other light gas. Other light gas can be selected for example from N₂, CH₄ and C₃H₈; preferably from N₂ and CH₄.

A high affinity can be considered as an affinity for CO₂ higher than the affinity for CO₂ of a benzene ring.

A cross-linker, or a group, having a high affinity for CO₂ over other light gas can be identified through the use of Henry's constants (mole fractions). For example, a cross-linker, or a group, having a high affinity for CO₂ over other light gas can have a CO₂ Henry's Constant at 40° C. (atm) of at least 30, preferably of at least 40, more preferably of at least 50 and even more preferably of at least 70.

However, the cross-linker used in the present invention have a high affinity for CO₂ can also be selected according to the volume of CO₂ solubilized in an experimental design at controlled temperature and pressure. Hence, a cross-linker having a high affinity for CO₂ can, for example, solubilize more than 0.1 mol of CO₂ per liter of cross-linker. Preferably, a cross-linker having a high affinity for CO₂ can solubilize more than 0.2 mol of CO₂ per liter of cross-linker, more preferably more than 0.4 mol of CO₂ per liter of crosslinker, even more preferably more than 0.5 mol of CO₂ per liter of cross-linker.

In a preferred embodiment, the crosslinker will comprise at least a functional group having a high affinity for CO₂. For example, a functional group having a high affinity for CO₂ can have an interaction energy with CO₂ lower than −10 kJ·mol⁻¹.

A cross-linker according to an embodiment of the invention may have a heteroatom.

In a preferred embodiment, the crosslinker will comprise at least a functional group selected from:
a functional group comprising at least one π bond involving a heteroatom,
imidazolium, pyridinium, quaternary ammonium, triazolium, pyrrolidinium, piperidinium, morpholinium, azole alkane, sulfonium, phosphonium; and/or
A polar group such as ethylene glycol, polyol, fluoroalkyl, aromatic ring or nitrile.

In a more preferred embodiment, the cross-linker comprises at least a functional group selected from:
a functional group comprising at least one π bond involving a hetero atom, and/or
imidazolium, pyridinium, quaternary ammonium, triazolium, pyrrolidinium, piperidinium, morpholinium, azole alkane, sulfonium, and/or phosphonium.

In an even more preferred embodiment, the crosslinker comprises at least a functional group selected from
phosphonium;
ammonium, preferably quaternary ammonium; and/or
imidazolium.

The at-least one group having high affinity to CO₂ may comprise at least an imidazolium functional group and at least one ammonium functional group.

For example, the cross-linker comprises at least two functional groups having a high affinity for CO₂. In such an embodiment, the at least two functional groups having a high affinity for CO₂ can be different and the cross-linker can comprise:
a phosphonium and an ammonium;
an imidazolium and a phosphonium; or
an imidazolium and an ammonium.

In a particular embodiment and as it will be shown in example, the functional group having a high affinity for CO₂ will comprise at least one π bond involving a heteroatom, more preferably, it will comprise at least one carbon-heteroatom π bond. More preferably, the functional group having an high affinity for CO₂ will comprise at least one π bond involving an oxygen, nitrogen or sulfur atom, more preferably, it will comprise at least one carbon-(oxygen, nitrogen or sulfur atom) π bond.

An “oxygen group,” also called an “oxygen-bonded group,” is a chemical moiety having at least one free valence on an oxygen atom. Exemplary “oxygen groups” include, but are not limited to, hydroxy (—OH), —OR, —OC(O)R, —OSiR₃, —OPR₂, —OAlR₂, —OSiR₂, —OGeR₃, —OSnR₃, —OSO₂R, —OSO₂OR, —OBR₂, —OB(OR)₂, —OAlR₂, —OGaR₂, —OP(O)R₂, —OAs(O)R₂, —OAlR₂, and the like, including substituted analogs thereof. In an “oxygen group” having more than one free valency, the other free valences can be on atom(s) other than oxygen, for example carbon, in accord with the rules of chemical structure and bonding.

A “sulfur group,” also called a “sulfur-bonded group,” is a chemical moiety having at least one free valence on a sulfur atom. Exemplary “sulfur group(s)” include, but are not limited to, —SH, —SR, —SCN, —S(O)R, —SO₂R, and the like, including substituted analogs thereof. In a “sulfur group” having more than one free valency, the other free valences can be on atom(s) other than sulfur, for example carbon, in accord with the rules of chemical structure and bonding.

A “nitrogen group,” also called a “nitrogen-bonded group,” is a chemical moiety having at least one free valence on a nitrogen atom. Exemplary “nitrogen groups” include, but are not limited to, an aminyl group (—NH₂), an N-substituted aminyl group (—NRH), an N,N-disubstituted aminyl group (—NR₂), a hydrazido group (—NHNH₂), an N-substituted hydrazido group (—NRNH₂), an N²-substituted hydrazido group (—NHNRH), an N²,N²-disubstituted hydrazido group (—NHNR₂), a nitro group (—NO₂), an azido group (—N₃), an amidyl group (—NHC(O)R), an N-substituted amido group (—NRC(O)R), and the like, including substituted analogs thereof. In a “nitrogen group” having more than one free valency, the other free valences can be on any atom(s) in the group in accord with the rules of chemical structure and bonding, including atoms other than nitrogen, for example, carbon.

A “phosphorus group,” also called a “phosphorus-bonded group,” is a chemical moiety having at least one free valence on a phosphorus atom. Exemplary “phosphorus groups include, but are not limited to, —PH₂, —PHR, —PR₂, —P(O)R₂, —P(OR)₂, —P(O)(OR)₂, —P(NR₂)₂, —P(O)(NR₂)₂, and the like, including substituted analogs thereof. In a “phosphorus group” having more than one free valency, the other free valences can be on any atom(s) in the group in accord with the rules of chemical structure and bonding, including atoms other than phosphorus, for example, carbon.

The cross-linker according to the invention may have at least one, preferably at least two, radically polymerizable group.

According to the present invention, the at-least two radically polymerizable groups are configured to react, in a radical polymerization reaction, with the polymerizable IL, said polymerizable groups preferably containing double bond.

Hence, the cross-linker in a composition according to the invention comprises preferably at least two radically polymerizable double bonds groups.

Several polymerization and cross-link solution have been proposed. The inventors determined that in the context of the present invention, a cross-linker comprising at least two polymerizable groups configured to react in a radical polymerization reaction will provide the best results.

In a preferred embodiment, the cross-linker comprises at least a region of overlapping p orbitals allowing a delocalization of π electrons across all the adjacent p orbitals.

In particular, the cross-linker can comprise two radically polymerizable double bonds groups, three radically polymerizable double bonds groups or four radically polymerizable double bonds groups.

The two radically polymerizable groups of the cross-linker can be selected from: vinyl, 1,3-diene, styrene, halogenated alkene, vinyl ester, acrylate, acrylonitrile, acrylamide, N-vinylcarbozole, N-vinylpyrrolidone, or their combination (See: Odian, G. Principles of Polymerization, 4^{th} ed.; John Wiley & Sons: Hoboken, N J, 2004, p. 200 (Table 3-1) for a list of common radically polymerizable groups, the entire disclosure of which, except for any definitions, disclaimers, disavowals, and inconsistencies, is incorporated herein by reference).

A functional group comprising at least one π bond involving a heteroatom may be selected from:
tri(ethylene glycol) diacrylate;
pentaerythritol triacrylate;
1,3,5-triallyl-1,3,5-triazine-2,4,6(1H,3H,5H)-trione;
pentaerythritol tetraacrylate;
ethylene oxide;
charged group, organic group; and/or imidazolium, pyridinium, quaternary ammonium, triazolium, pyrrolidinium, piperidinium, morpholinium, azole alkane, sulfonium, and/or phosphonium.

A cross-linker according to the invention may comprise several functional groups having a high affinity for CO₂ associated each with a radically polymerizable double bond group. Hence, a cross-linker according to the invention can be a cross-linker of formula II:

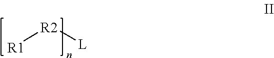

Wherein
R1 comprises at least one radically polymerizable double-bond group;
R2 comprises at least a functional group having a high affinity for CO₂;
L refer to any carbon containing group capable of being a central point to bond with a functional group having a high affinity for CO₂; for example, L is selected from an organyl group, a hydrocarbyl group; an alkyl group; an aliphatic group; a cycloalkyl group; an alkenyl group; an alkynyl group; an aromatic group; an aryl group; a heterocyclyl group; a cycloheteryl group; a heteroaryl group; an arylheteryl group; an organoheteryl group; an aralkyl group; a heteroaralkyl group; a halide; substituted or not;
n is an integer starting from 2.

In one aspect, a chemical “group” describes derived from a reference compound, for example, by the number of hydrogen atoms that are formally removed from the reference compound to generate the group, even if that group is not literally synthesized in this manner. These groups can be utilized as substituents or coordinated or bonded to metal atoms.

Many groups are specified according to the atom that is bonded to the metal or bonded to another chemical moiety as a substituent. Also, any carbon-containing group for which the number of carbon atoms is not specified can have, according to proper chemical practice, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 carbon atoms, or any range or combination of ranges between these values.

### L Groupment

L refers to any carbon containing group capable of being a central point for a functional group having a high affinity for CO₂ to bond with.

L may be selected from organyl group that is used herein in accordance with an organic substituent group, regardless of functional type, having one free valence at a carbon atom.

For example, L may correspond to acrylate groups such as methacrylate, or other substituents well known from the skilled person, such as ethyl acrylate, butyl acrylate etc.

Similarly, organyl group may comprise an “organylene group” referring to an organic group, regardless of functional type, derived by removing two hydrogen atoms from an organic compound, either two hydrogen atoms from one carbon atom or one hydrogen atom from each of two different carbon atoms. An “organic group” refers to a generalized group formed by removing one or more hydrogen atoms from carbon atoms of an organic compound. Thus, an “organyl group,” an “organylene group,” and an “organic group” can contain organic functional group(s) and/or atom(s) other than carbon and hydrogen, that is, an organic group that can comprise functional groups and/or atoms in addition to carbon and hydrogen. For instance, non-limiting examples of atoms other than carbon and hydrogen include halogens, oxygen, nitrogen, phosphorus, and the like. Non-limiting examples of functional groups include ethers, aldehydes, ketones, esters, sulfides, amines, and phosphines, and so forth. In one aspect, the hydrogen atom(s) removed to form the “organyl group,” “organylene group,” or “organic group” can be attached to a carbon atom belonging to a functional group, for example, an acyl group (—C(O)R), a formyl group (—C(O)H), a carboxy group (—C(O)OH), a hydrocarboxycarbonyl group (—C(O)OR), a cyano group (—C═N), a carbamoyl group (—C(O)NH₂), a N-hydrocarbylcarbamoyl group (—C(O)NHR), or N,N′-dihydrocarbylcarbamoyl group (—C(O)NR₂), among other possibilities. In another aspect, the hydrogen atom(s) removed to form the “organyl group,” “organylene group,” or “organic group” can be attached to a carbon atom not belonging to, and remote from, a functional group, for example, —CH₂C(O)CH₃, —CH₂NR₂, and the like. An “organyl group,” “organylene group,” or “organic group” can be aliphatic, inclusive of being cyclic or acyclic, or can be aromatic. “Organyl groups,” “organylene groups,” and “organic groups” also encompass heteroatom-containing rings, heteroatom-containing ring systems, heteroaromatic rings, and heteroaromatic ring systems. “Organyl groups,” “organylene groups,” and “organic groups” can be linear or branched. Finally, it is noted that the “organyl group,” “organylene group,” or “organic group” include “hydrocarbyl group,” “hydrocarbylene group,” “hydrocarbon group,” respectively, and “alkyl group,” “alkylene group,” and “alkane group,” respectively, as members. The term “hydrocarbon” refers to a compound containing only carbon and hydrogen. The term “hydrocarbyl group” is used herein in accordance with a univalent group formed by removing a hydrogen atom from a hydrocarbon. Non-limiting examples of hydrocarbyl groups include ethyl, phenyl, tolyl, propenyl, and the like. Similarly, hydrocarbyl group may comprise a “hydrocarbylene group” referring to a group formed by removing two hydrogen atoms from a hydrocarbon, either two hydrogen atoms from one carbon atom or one hydrogen atom from each of two different carbon atoms. A “hydrocarbyl group,” “hydrocarbylene group,” and “hydrocarbon group” can be aliphatic or aromatic, acyclic or cyclic groups, and/or linear or branched. A “hydrocarbyl group,” “hydrocarbylene group,” and “hydrocarbon group” can include rings, ring systems, aromatic rings, and aromatic ring systems, which contain only carbon and hydrogen. “Hydrocarbyl groups,” “hydrocarbylene groups,” and “hydrocarbon groups” include, byway of example, aryl, arylene, arene groups, alkyl, alkylene, alkane group, cycloalkyl, cycloalkylene, cycloalkane groups, aralkyl, aralkylene, and aralkane groups, respectively, among other groups as members.

L may be selected from an aliphatic group or aliphatic compound that is a class of acyclic or cyclic, saturated or unsaturated, carbon compounds, that excludes aromatic compounds. An “aliphatic group” is a generalized group formed by removing one or more hydrogen atoms (as necessary for the particular group) from carbon atom of an aliphatic compound. Aliphatic compounds can contain organic functional group(s) and/or atom(s) other than carbon and hydrogen.

L may be selected from alkane group or compound refers to a saturated hydrocarbon compound with or without particular groups in the alkane (e.g. halogenated alkane indicates that the presence of one or more halogen atoms replacing an equivalent number of hydrogen atoms in the alkane). Alkane may comprise alkyl group referring to a univalent group formed by removing a hydrogen atom from an alkane. Similarly, alkane group may comprise alkylene group referring to a group formed by removing two hydrogen atoms from an alkane (either two hydrogen atoms from one carbon atom or one hydrogen atom from two different carbon atoms) and “alkyl group,” “alkylene group,” and “alkane group” can be acyclic or cyclic groups, and/or can be linear or branched.

For example, cyclic group may comprise a cycloalkane that is a saturated cyclic hydrocarbon, with or without particular groups e.g. halogenated cycloalkane indicates that the presence of one or more halogen atoms replacing an equivalent number of hydrogen atoms in the cycloalkane. Cycloalkanes may comprise unsaturated cyclic hydrocarbons having one endocyclic double or one triple bond are called cycloalkenes and cycloalkynes, respectively. Cycloalkane that is a saturated cyclic hydrocarbon, with or without particular groups e.g. halogenated alkene” refers to a linear or branched hydrocarbon olefin that has one carbon-carbon double bond and the general formula CₙH₂n.

A “cycloalkyl group” is a univalent group derived by removing a hydrogen atom from a ring carbon atom from a cycloalkane. Similarly, a “cycloalkylene group” includes both a group derived from a cycloalkane in which two hydrogen atoms are formally removed from the same ring carbon, a group derived from a cycloalkane in which two hydrogen atoms are formally removed from two different ring carbons, and a group derived from a cycloalkane in which a first hydrogen atom is formally removed from a ring carbon and a second hydrogen atom is formally removed from a carbon atom that is not a ring carbon. A “cycloalkane group” refers to a generalized group formed by removing one or more hydrogen atoms (as necessary for the particular group and at least one of which is a ring carbon) from a cycloalkane.

L may be selected from alkene group that refers to a linear or branched hydrocarbon olefin that has one carbon-carbon double bond and the general formula CₙH₂ₙ. Alkene may comprise alkadienes referring to a linear or branched hydrocarbon olefin having two carbon-carbon double bonds, alkatrienes referring to linear or branched hydrocarbon olefins having three carbon-carbon and the general formula CₙH₂ₙ₋₄. More carbon-carbon double bond according to the same reasoning may be present but not explain here. Other particular groups within an alkene group may be used.

L may be selected from an alkenyl group that is a univalent group derived from an alkene by removal of a hydrogen atom from any carbon atom of the alkene. Thus, “alkenyl group” includes groups in which the hydrogen atom is formally removed from a sp² hybridized (olefinic) carbon atom and groups in which the hydrogen atom is formally removed from any other carbon atom. Similarly, alkenyl group may comprise an “alkenylene group” referring to a group formed by formally removing two hydrogen atoms from an alkene, either two hydrogen atoms from one carbon atom or one hydrogen atom from two different carbon atoms. Alkenyl group may also comprise “alkyne” referring to a linear or branched hydrocarbon olefin that has one carbon-carbon triple bond and the general formula CₙH₂ₙ₋₂. The group may also comprise alkadiynes referring to a hydrocarbon olefin having two carbon-carbon double bonds and the general formula CₙH₂ₙ₋₆ and alkatriynes referring to hydrocarbon olefins having three carbon-carbon and the general formula CₙH₂ₙ₋₁₀. More carbon-carbon double bond according to the same reasoning may be present but not explain here. Other particular groups within an alkyne group may be used.

L may be selected from an “alkynyl group” that is a univalent group derived from an alkyne by removal of a hydrogen atom from any carbon atom of the alkyne. Thus, “alkynyl group” includes groups in which the hydrogen atom is formally removed from a sp hybridized (acetylenic) carbon atom and groups in which the hydrogen atom is formally removed from any other carbon atom. Similarly, alkynyl group may comprise an “alkynylene group” referring to a group formed by formally removing two hydrogen atoms from an alkyne, either two hydrogen atoms from one carbon atom if possible or one hydrogen atom from two different carbon atoms. More carbon-carbon double bond according to the same reasoning may be present but not explain here. Other particular groups within an alkynyl group may be used.

L may be selected from an “aromatic group” that refers to a generalized group formed by removing one or more hydrogen atoms from an aromatic compound. Thus, an “aromatic group” refers to a group derived by removing one or more hydrogen atoms from an aromatic compound, that is, a compound containing a cyclically conjugated hydrocarbon Aromatic compounds or “aromatic groups” can be monocyclic or polycyclic. Aromatic compounds include “arenes” and “heteroarenes,” also termed “hetarenes”. Aromatic compounds, arenes, and heteroarenes can be mono- or polycyclic. Examples of arenes include, but are not limited to, benzene, naphthalene, and toluene, among others. Examples of heteroarenes include, but are not limited to furan, pyridine, and methylpyridine, among others. An aromatic group can be further bonded to a metal, transitional metal.

L may be selected from an “aryl group” that is a group derived from the formal removal of a hydrogen atom from an aromatic hydrocarbon ring carbon atom from an arene compound. Similarly, aryl group may comprise an “arylene group” referring to a group formed by removing two hydrogen atoms from an arene.

L may be selected from a “heterocyclic group” that is a group having at least two different elements as ring member atoms. For example, heterocyclic group can comprise rings containing carbon and nitrogen, carbon and oxygen, carbon and sulfur. Heterocyclic groups can be either aliphatic or aromatic and may be bonded to a metal.

L may be selected from a “heterocyclyl group” that is a univalent group formed by removing a hydrogen atom from a heterocyclic ring or ring system carbon atom of a heterocyclic compound. Similarly, heterocyclyl group may comprise a “heterocyclylene group” or more simply, a “heterocyclene group,” referring to a group by removing one or more hydrogen atoms from a heterocyclic compound. “heterocyclyl group,” “heterocyclylene group,” and “heterocyclic group” can be further bonded to a transition metal.

L may be selected from a “cycloheteryl group” is a univalent group formed by removing a hydrogen atom from a heterocyclic ring or ring system heteroatom of a heterocyclic compound. Similarly, cycloheteryl group may comprise a “cycloheterylene group” referring to a group formed by removing two hydrogen atoms from an heterocyclic compound, at least one of which is removed from a heterocyclic ring or ring system heteroatom of the heterocyclic compound; the other hydrogen atom can be removed from any other atom, including for example, a heterocyclic ring or ring system ring carbon atom, another heterocyclic ring or ring system heteroatom, or a non-ring atom (carbon or heteroatom). Similarly, cycloheteryl group may comprise “cyclohetero group” referring to a generalized group formed by removing one or more hydrogen atoms from a heterocyclic compound. A “cycloheteryl group,” “cycloheterylene group,” and “cyclohetero group” can be further bonded to a transition metal.

L may be selected from a “heteroaryl group” is a class of “heterocyclyl group” and is a univalent group formed by removing a hydrogen atom from a heteroaromatic ring or ring system carbon atom of a heteroarene compound. Similarly, heteroaryl group may comprise a “heteroarylene group” referring to a group formed by removing two hydrogen atoms from a heteroarene compound, at least one of which is from a heteroarene ring or ring system carbon atom. The group may comprise “heteroarene group” referring to a generalized group formed by removing one or more hydrogen atoms from a heteroarene compound. A “heteroaryl group,” “heteroarylene group,” and “heteroarene group” can be further bonded to a transition metal.

L may be selected from an “arylheteryl group” that is a class of “cycloheteryl group” and is a univalent group formed by removing a hydrogen atom from a heteroaromatic ring or ring system heteroatom of a heteroaryl compound. By specifying that the hydrogen atom is removed from of a heteroaromatic ring or ring system heteroatom and not from a heteroaromatic ring or ring system carbon atom, an “arylheteryl group” is distinguished from an “heteroaryl group” in which a hydrogen atom is removed from a heteroaromatic ring or a ring system carbon atom. Similarly, arylheteryl group may comprise an “arylheterylene group” referring to a group formed by removing two hydrogen atoms from an heteroaryl compound, at least one of which is removed from a heteroaromatic ring or ring system heteroatom of the heteroaryl compound; the other hydrogen atom can be removed from any other atom. Similarly, arylheteryl group may comprise an “arylhetero group” referring to a generalized group formed by removing one or more hydrogen atoms (as necessary for the particular group and at least one of which is from a heteroaromatic ring or ring system) heteroatom from a heteroarene compound. “Arylheteryl group,” “arylheterylene group,” and “arylhetero group” can be further bonded to a transition metal,

L may be selected from an “organoheteryl group” that is a univalent group containing carbon, which are thus organic, but which have their free valence at an atom other than carbon. Organoheteryl groups can be cyclic or acyclic, and/or aliphatic or aromatic, Similarly, organoheteryl group may comprise an “organoheterylene group” as divalent group containing carbon and at least one heteroatom having two free valences, at least one of which is at a heteroatom. Similarly, organoheteryl group may comprise an “organohetero group” that is a generalized group containing carbon and at least one heteroatom having one or more free valences from an organohetero compound. An “organoheteryl group,” an “organoheterylene group,” or an “organohetero group” can be further bonded to a transition metal.

L may be selected from a “aralkyl group” that is an aryl-substituted alkyl group having a free valance at a non-aromatic carbon atom, for example, a benzyl group. Similarly, aralkyl group may comprise an “aralkylene group” as an aryl-substituted alkylene group having two free valances at a single non-aromatic carbon atom or a free valence at two non-aromatic carbon atoms while an “aralkane group” is a generalized is an aryl-substituted alkane group having one or more free valances at a non-aromatic carbon atom(s). A “heteroaralkyl group” is a heteroaryl-substituted alkyl group having a free valence at a non-heteroaromatic ring or ring system carbon atom. Similarly a aralkyl group may comprise an “heteroaralkylene group” that is a heteroaryl-substituted alkylene group having a two free valances at a single non-heteroaromatic ring or ring system carbon atom or a free valence at two non-heteroaromatic ring or ring system carbon atoms while a “heteroaralkane group” is a generalized aryl-substituted alkane group having one or more free valances at a non-heteroaromatic ring or ring system carbon atom(s).

Furthermore, a group may be “substituted” that is intended to describe any non-hydrogen moiety that formally replaces a hydrogen in that group, and is intended to be non-limiting. A group or groups can also be referred to herein as “unsubstituted” or by equivalent terms such as “non-substituted,” which refers to the original group in which a non-hydrogen moiety does not replace a hydrogen within that group. “Substituted” is intended to be non-limiting and include inorganic substituents or organic substituents.

For each of the specific groups in which the free valence is situated on a heteroatom (non-carbon atom), such as the “oxygen group,” “sulfur group,” “nitrogen group,” “phosphorus group,” and the like, such groups can include a general “R” moiety. In each instance, R can be independently an organyl group; alternatively, a hydrocarbyl group; alternatively, an alkyl group; alternatively, an aliphatic group; alternatively, a cycloalkyl group; alternatively, an alkenyl group; alternatively, an alkynyl group; alternatively, an aromatic group; alternatively, an aryl group; alternatively, a heterocyclyl group; alternatively, a cycloheteryl group; alternatively, a heteroaryl group; alternatively, an arylheteryl group; alternatively, an organoheteryl group; alternatively, an aralkyl group; alternatively, a heteroaralkyl group; or alternatively, a halide.

Hence, a cross-linker according to the invention can be a cross-linker of formula III:

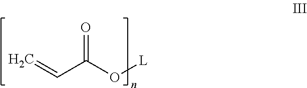

In particular, a cross-linker may be a cross-linker of formula IIIa:

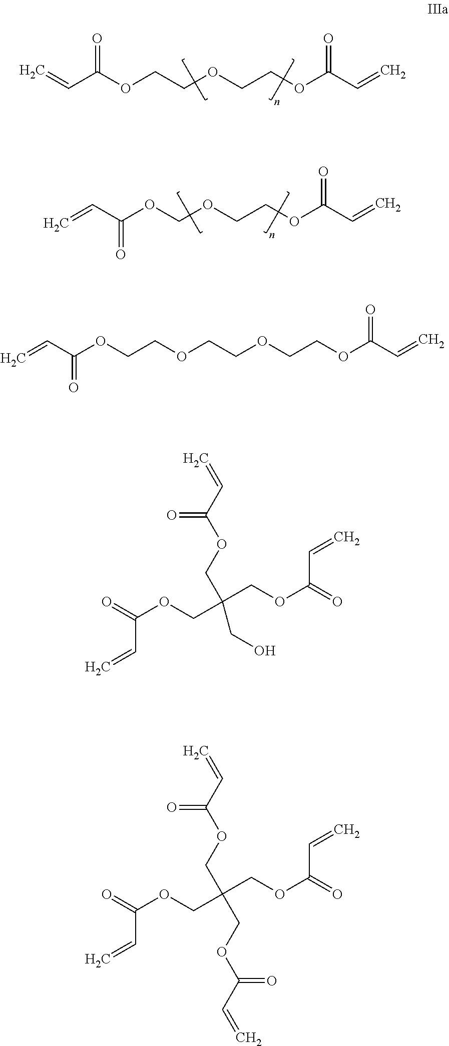

In a preferred embodiment, a cross-linker is selected from difunctional radical or trifunctional radical or tetrafunctional radical. For example, a cross-linker may be a triallyl isocyanurate, tri(ethylene glycol) diacrylate, pentaerythritol triacrylate, 1,3,5-triallyl-1,3,5-triazine-2,4,6(1H,3H,5H)-trione, pentaerythritol tetraacrylate, isocyanuric acid triallyl ester, triallylisocyanurate.

In a preferred embodiment, the functional group having a high affinity to CO₂ comprises at least an imidazolium functional group.

Imidazolium is a cationic heterocyclic aromatic organic group that has a strong affinity for the CO₂, preferably with formula [C₃N₂H₄]⁺. Imidazolium functional group can independently be selected from: biotin, histidine, histamine, nitroimidazole, prochloraz, purine and its derivatives (adenine, guanine), benznidazole, diethyl carbonate, imidazoline, imidazolidine.

For example, the cross-linker can be a cross-linker of formula IV:

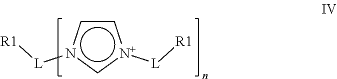

Wherein
R1 is independently selected from at least one radically polymerizable double bond group
L is independently selected from an organyl group, a hydrocarbyl group; an alkyl group; an aliphatic group; a cycloalkyl group; an alkenyl group; an alkynyl group; an aromatic group; an aryl group; a heterocyclyl group; a cycloheteryl group; a heteroaryl group; an arylheteryl group; an organoheteryl group; an aralkyl group; a heteroaralkyl group; a halide; substituted or not;
n is an integer which can be selected from 1 to 10.

In particular, a cross-linker comprising an imidazolium functional group can be selected from

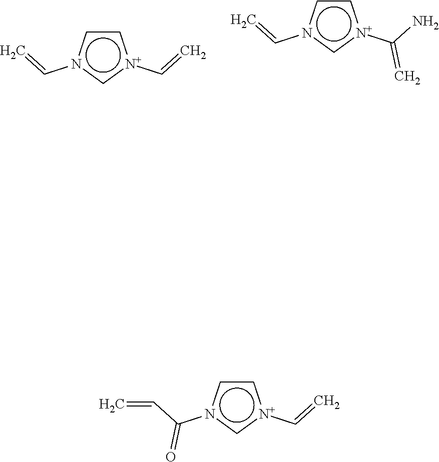

In a preferred embodiment, the at-least one group having high affinity to CO₂ comprises at least an ammonium functional group.

Ammonium has a strong affinity for the CO₂, and may correspond to a primary, secondary, tertiary, quaternary ammonium.

For example, the cross-linker can be a crosslinker of formula V:

R1-L-(AMO-L-R1)n V

Wherein
R1 is independently selected from at least one radically polymerizable double bond group
L is independently selected from an organyl group, a hydrocarbyl group; an alkyl group; an aliphatic group; a cycloalkyl group; an alkenyl group; an alkynyl group; an aromatic group; an aryl group; a heterocyclyl group; a cycloheteryl group; a heteroaryl group; an arylheteryl group; an organoheteryl group; an aralkyl group; a heteroaralkyl group; a halide; substituted or not;
AMO is independently selected from R—NH, R—NH₂, R—NH₃, NH₄, wherein R may comprise an an organyl group, a hydrocarbyl group; an alkyl group; an aliphatic group; a cycloalkyl group; an alkenyl group; an alkynyl group; an aromatic group; an aryl group; a heterocyclyl group; a cycloheteryl group; a heteroaryl group; an arylheteryl group; an organoheteryl group; an aralkyl group; a heteroaralkyl group; a halide; substituted or not; and may comprise, a “nitrogen group,” having at least one free valence on a nitrogen atom;
n is an integer which can be selected from 1 to 10.

Exemplary, but not limited to, the AMO is a nitrogen group comprising an aminyl group (—NH₂), an N-substituted aminyl group (—NRH), an N,N-disubstituted aminyl group (—NR₂), a hydrazido group (—NHNH₂), an N1-substituted hydrazido group (—NRNH₂), an N2-substituted hydrazido group (—NHNRH), an N2,N2-disubstituted hydrazido group (—NHNR₂), a nitro group (—NO₂), an azido group (—N₃), an amidyl group (—NHC(O)R), an N-substituted amido group (—NRC(O)R), and the like, including substituted analogs thereof. In a “nitrogen group” having more than one free valency, the other free valences can be on any atom(s) in the group in accord with the rules of chemical structure and bonding, including atoms other than nitrogen, for example, carbon.

In particular, a cross-linker comprising an ammonium functional group can be selected from:

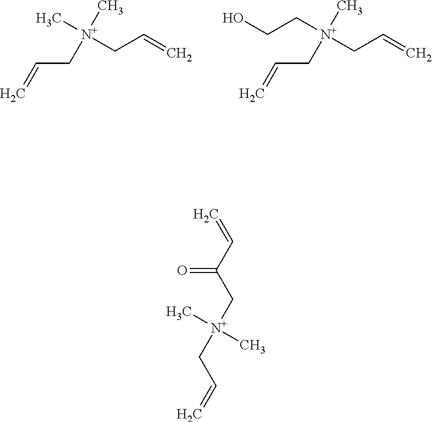

In a preferred embodiment, the at-least one group having high affinity to CO₂ comprises at least a phosphonium functional group.

Phosphonium has a strong affinity for the CO₂, and may correspond to chemical formula PR₄⁺.

For example, the cross-linker can be a cross-linker of formula VI:

R1-L-(PHOS-L-R1)n VI

Wherein
R1 is independently selected from at least one radically polymerizable double bond op group
L is independently selected from an organyl group, a hydrocarbyl group; an alkyl group; an aliphatic group; a cycloalkyl group; an alkenyl group; an alkynyl group; an aromatic group; an aryl group; a heterocyclyl group; a cycloheteryl group; a heteroaryl group; an arylheteryl group; an organoheteryl group; an aralkyl group; a heteroaralkyl group; a halide; substituted or not;
PHOS is independently selected from PH₂, —PHR, —PR₂, —P(O)R₂, —P(OR)₂, —P(O)(OR)₂, —P(NR₂)₂, —P(O)(NR₂)₂, and the like, including substituted analogs thereof; phosphines (primary, secondary and tertiary), phosphonium iodine, organophosphonium, wherein R may be selected from an organyl group, a hydrocarbyl group; an alkyl group; an aliphatic group; a cycloalkyl group; an alkenyl group; an alkynyl group; an aromatic group; an aryl group; a heterocyclyl group; a cycloheteryl group; a heteroaryl group; an arylheteryl group; an organoheteryl group; an aralkyl group; a heteroaralkyl group; a halide; substituted or not;
n is an integer which can be selected from 1 to 10.

In particular, a cross-linker comprising a phosphonium functional group can be selected from:

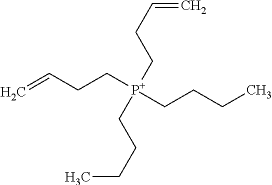 [SMILES: C=CCC[P+](CCC=C)(CCCC)CCCC]

In some embodiment, the cross-linker is preferably selected from:

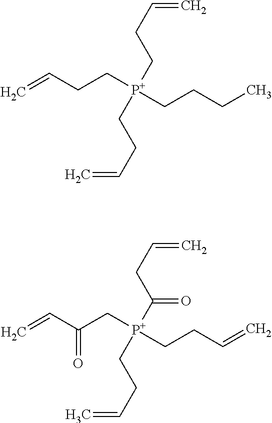

In a preferred embodiment, the at-least one group having high affinity to CO₂ comprises at least a pyridinium functional group.

Pyridinium have a strong affinity for the CO₂, and may correspond to chemical formula:

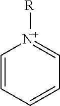

For example, the cross-linker can be a cross-linker of formula VII:

R1-L-(PYR-L-R1)n(X-)n VII

Wherein
R1 is independently selected from at least one radically polymerizable double bond group;
L is independently selected from an organyl group, a hydrocarbyl group; an alkyl group; an aliphatic group; a cycloalkyl group; an alkenyl group; an alkynyl group; an aromatic group; an aryl group; a heterocyclyl group; a cycloheteryl group; a heteroaryl group; an arylheteryl group; an organoheteryl group; an aralkyl group; a heteroaralkyl group; a halide; substituted or not;
PYR is independently selected from C₅H₅N, R—C₅H₄N, R₂C₅H₃N, R₃C₅H₂N, R₄—C₅HN, R₅C₅N, wherein R may be a hydrogen or independently selected from an organyl group, a hydrocarbyl group; an alkyl group; an aliphatic group; a cycloalkyl group; an alkenyl group; an alkynyl group; an aromatic group; an aryl group; a heterocyclyl group; a cycloheteryl group; a heteroaryl group; an arylheteryl group; an organoheteryl group; an aralkyl group; a heteroaralkyl group; a halide; substituted or not
n is an integer which can be selected from 1 to 10.

In particular, a cross-linker comprising a pyridinium functional group can be selected from:

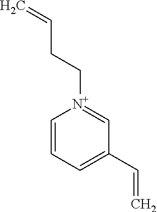

In some embodiment, the cross-linker is preferably selected from:

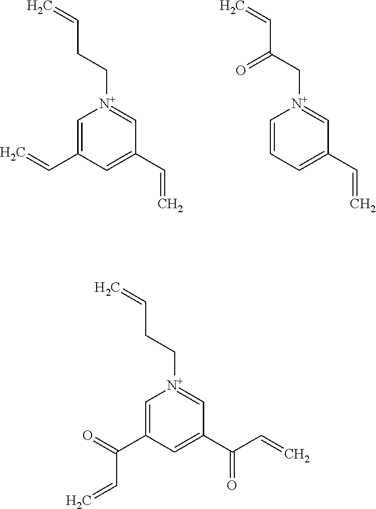 [SMILES: C=CCC[n+]1cc(C=C)cc(C=C)c1 ; C=CC(=O)C[n+]1cccc(C=C)c1 ; C=CCC[n+]1cc(C(=O)C=C)cc(C(=O)C=C)c1]

In a preferred embodiment, the at-least one group having high affinity to CO₂ comprise at least a functional group comprising at least one π bond involving or not a hetero atom and/or a polar group such as ethylene glycol, polyol, fluoroalkyl, aromatic ring or nitrile.

Reinforced by the at-least one π bond and/or the at-least one polar group, the cross-linker have a strong affinity for the CO₂. The cross-linker may comprise at least a region of overlapping p orbitals allowing a delocalization of π electrons across all the adjacent p orbitals.

The cross-linker may comprise two radically polymerizable double bonds groups, three radically polymerizable double bonds groups or four radically polymerizable double bonds groups.

For example, the crosslinker can be a cross-linker of formula VIII:

R1-L-(Y-L-R1)n(X-)n VIII

Wherein
R1 is independently selected from at least one radically polymerizable double bond group;
L is independently selected from an organyl group, a hydrocarbyl group; an alkyl group; an aliphatic group; a cycloalkyl group; an alkenyl group; an alkynyl group; an aromatic group; an aryl group; a heterocyclyl group; a cycloheteryl group; a heteroaryl group; an arylheteryl group; an organoheteryl group; an aralkyl group; a heteroaralkyl group; a halide; substituted or not;
Y is independently selected from an organyl group, a hydrocarbyl group; an alkyl group; an aliphatic group; a cycloalkyl group; an alkenyl group; an alkynyl group; an aromatic group; an aryl group; a heterocyclyl group; a cycloheteryl group; a heteroaryl group; an arylheteryl group; an organoheteryl group; an aralkyl group; a heteroaralkyl group; a halide; substituted or not, comprising or not at least one heteroatom,
n is an integer which can be selected from 1 to 10.

In some embodiments, a cross-linker of use in a composition or MMM of the present invention can further comprise at least one polar group which is not a functional group with high affinity for CO₂. For example, a cross-linker according to the invention can comprise a functional group selected from: ether, ethylene glycol, fluoroalkyl, aromatic ring or nitrile.

In some embodiments, the cross-linker may comprise a polar bound for example halogen (fluoro, chloro, bromo, iodo), hydroxy, ether, aldehydes and carbonyl, ketone, carboxyl, amine and their derivatives, thiol.

In particular, a cross-linker comprising at least a functional group comprising at least one π bond involving or not a hetero atom and/or a polar group can be selected from:

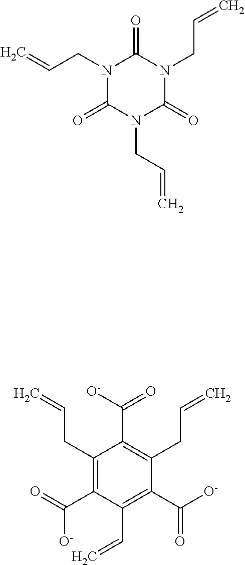 [SMILES: C=CCn1c(=O)n(CC=C)c(=O)n(CC=C)c1=O ; C=CCc1c(C(=O)[O-])c(C=C)c(C(=O)[O-])c(CC=C)c1C(=O)[O-]]

According to another aspect, the invention relates to a mixed-matrix membrane formed from a composition according to the invention.

In particular, the invention relates to a mixed-matrix membrane comprising:
at least one porous solid additive having a charged surface;
an IL; and
a polymerized matrix comprising a PIL covalently linked with a cross-linker;
wherein the cross-linker have a high affinity to CO₂ over other light gas, in particular, a higher affinity to CO₂ than to other light gases and the PIL is covalently linked with the cross-linker through a polymerizable group of the cross-linker able to react, in a radical polymerization reaction, with the PIL, said polymerizable groups preferably containing double bond.

Preferably, the cross-linker comprises at least one functional group having high affinity to CO₂ over other light gas.

In a preferred embodiment, the PIL is covalently linked with the cross-linker through a polymerizable group of the cross linker configured to react, in a radical polymerization reaction, with the PIL, said polymerizable groups preferably containing double bond; and the cross-linker comprises at least one group having high affinity to CO₂ over other light gases.

The MMM may be used for gas separation, permitting passage of desired gaseous components, preferably carbon dioxide and methane.

The membrane may allow the passage of gaseous components at different diffusion rates, such that one of the components, for example either carbon dioxide or methane, diffuses at a faster rate through the membrane. In a preferred embodiment, the rate at which carbon dioxide passes through the polymer is at least 10 times faster than the rate at which methane passes through the polymer.

For improving the permeability of the membrane, it may be possible to make an active layer thinner, and faster roll-to-roll casting may allow for better film homogeneity at a larger scale.

Generally, the thickness of the thin membrane can be selected such that the mechanical stability of the membrane is suitably improved.

The larger the thin membrane, the lower is the permeability of the thin membrane. Therefore, the thickness is selected such that an acceptable compromise between the permeability and the mechanical stability is achieved. The membrane may be rigid, rubbery, or flexible.

The mixed matrix membrane is preferably in the form of a film, tube, or other conventional shapes used for gas separations.

According to another aspect, the invention relates to the use of a MMM of the invention for gas separation, preferably CO₂ separation.

In particular, the invention relates to the use of a MMM of the invention for CO₂ separation at a pressure higher than 40 bars, preferably higher than 50 bars.

In particular, the invention relates to the use of a MMM of the invention for CO₂ separation at a temperature higher than 50° C., preferably higher than 60° C.

More preferably, the invention relates to the use of a MMM of the invention for CO₂ separation at a pressure higher than 50 bars and a temperature higher than 60° C.

According to another aspect, the present invention concerns a separation system including a membrane according to the invention.

A separation system is preferably a gas separation system.

The separation system may include an outer perforated shell surrounding one or more inner tubes that contain the mixed matrix membranes.

The separation system may also comprise at least an inlet and at least an outlet. The inlet allows feeding the system in fluid, preferably gas, and the outlet, the contaminants to leave.

For example, the gaseous mixture passes upward through the inner tubes. As the gaseous mixture passes through the inner tubes, one or more components of the mixture permeate out of the inner tubes through the mixed-matrix membrane.

The mixed-matrix membranes can be included in a cartridge and used for permeating contaminants from a gaseous mixture. The contaminants can permeate out through the membrane, while the desired components continue out the top of the membrane. The membranes may be stacked within a perforated tube to form the inner tubes or may be interconnected to form a self-supporting tube.

Each one of the mixed matrix membranes may be designed to permeate one or more components of the gaseous mixture.

The membranes may be removable and replaceable in a system. So, the system may also comprise membrane arranged in series, in parallel or in combinations.

Advantageously, a separation system including the membranes may be of a variable length.

The gaseous mixture can flow through the membrane(s) following an inside-out flow path or following an outside-in flow path.

The membranes are preferably durable, resistant to high temperatures, and resistant to high pressure as explained, so the system is also more resistant and more durable over time.

According to another aspect, the present invention concerns a method of manufacturing MMM.

The method according to the invention comprises a living chain-addition polymerization step based on a polymerizable IL and the cross-linker having a high affinity for CO₂, in particular, a higher affinity for CO₂ than for other light gases; and at least two polymerizable groups configured to react, in a radical polymerization reaction, with the IL monomer, said polymerizable groups preferably containing double bond.

Preferably, the polymerizable IL comprises less than 3 repeated units.

The method according to the invention may comprise a step of synthesis of a controlled length IL oligomer, a ring-opening metathesis polymerization (ROMP) step, a step of control of chain addition polymerization, a formation of ultrathin layer.

The resulting mixed-matrix membrane is similar to a grafted polymer, which better resist plasticization and swelling.

The method according to the invention proposes to use living ring-opening metathesis polymerization (ROMP) chemistry. Preferably, ROMP is performed on norbornene and oxanorbornene monomers bearing imidazolium Tf₂N⁻ units to obtain uniform, controlled-length IL oligomers with alkyl backbones and more CO₂-soluble ether-bearing backbones.

MMMs can be formed by any method allowing polymerization, preferably radical. More preferably, the MMMs can be formed by ROMP.

Advantageously, ROMP is compatible with a wide range of chemical groups and has with a high degree of molecular weight control and low polydispersity.

In order to improve the method, ROMP step may be performed on simple imidazolium-based norbornene monomers to make uniform, low-molecular-weight IL oligomers and block copolymers, including the first type of proposed IL oligomer.

ROMP is a chain-growth polymerization which converts cyclic olefins to a polymeric material in the presence of transition-metal-based complexes such as Ti, Mo, W, Ta, Re, Ru. ROMP is a type of olefin metathesis polymerization in which the driving force of the reaction is relief of ring strain in cyclic olefins (e.g., norbornene or cyclopentene). Therefore, transformation reactions of both polycyclic olefins such as norbornene; norbornadiene; dicyclopentadiene and low-strain cyclic olefins including cyclopentene; or cycloheptene allow extension of the range of attainable chain polymer.

In ROMP, the monomer can include a strained ring functional group, such as a norbornene functional group, a cyclopentene functional group, etc., to form the polymeric chains. For example, norbornene is a bridged cyclic hydrocarbon that has a cyclohexene ring bridged with a methylene group in the para position.

In a ROMP process, formation of a metal-carbene species is followed by attack of the double bond in the ring structure by the carbene, forming a highly strained metallacyclobutane intermediate. The ring then opens, giving the beginning of the polymer: a linear chain double-bonded to the metal with a terminal double bond as well. The new carbene reacts with the double bond on the next monomer, thus propagating the reaction.

The crucial step in ROMP for synthesis is the chain transfer process during the termination. ROMPs are widely terminated by the addition of an agent containing certain functional groups. This agent provides deactivation of the transition metal catalyst from the end of propagating chain and selective insertion of a functional group.

It is important to note that, as with all metathesis reactions, all steps are in principle reversible. Furthermore, the double bond of the monomer is formally preserved, resulting in one double bond per repeat unit. This high unsaturation of the resulting ROMP affects the stability versus oxygen of the resulting polymers.

Alternatively, instead of using a living ROMP to prepare controlled-length IL oligomers, controlled radical polymerization methods such as atom-transfer radical polymerization (ATRP) and reversible addition-fragmentation chain-transfer (RAFT) polymerization can be used.

### Example

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art can, using the preceding description and the following illustrative examples, make and utilize the compounds of the present invention and practice the claimed methods. The following working examples therefore, specifically point out the preferred embodiments of the present invention, and are not to be construed as limiting in any way the remainder of the disclosure.

As it has been detailed, the invention comprises the use of CO₂-selective commercial cross-linkers to produce a PIL matrix, such PIL matrix will preferably be cross-linked to a molecule having a high affinity for CO₂. These examples are in particular directed to such an aspect.

### 1. Materials

CO₂, CH₄, and He gas were purchased from Airgas, and of ultra-high purity (99.999%).

1-Vinyl-3-methylimidazolium bis(triflimide) ([VMIM][Tf₂N]) and 1-ethyl-3-methylimidazolium bis(triflimide) ([EMIM][Tf₂N]) were synthesized according to previously published literature methods (S. Li, J. L. Falconer, R. D. Noble, Improved SAPO-34 Membranes for CO₂/CH₄ Separations, Adv. Mater. 18, (2006) 2601-2603. https://doi.org/10.1002/adma.200601147), and their structures were confirmed via ¹H NMR spectroscopy and matched reported characterization data (Li et al., 2006).

The cross-linking compound divinylbenzene (DVB) and the radical photo-initiator such as the 2-hydroxy-2-methlpropiophenone (HMP) were purchased from Sigma-Aldrich and used as received.

SAPO-34 is synthesized using a procedure reported in prior literature (Y. Zheng, N. Hu, H. Wang, N. Bu, F. Zhang, R. Zhou, Preparation of steam-stable high-silica CHA (SSZ-13) membranes for CO₂/CH₄ and C₂H₄/C₂H₆ separation, J. Membr. Sci. 475 (2015) 303-310. https://doi.org/10.1016/j.memsci.2014.10.048). SAPO-34 is calcined at 600° C. and finely ground via mortar and pestle prior to use.

### 2. Crosslinker

Several molecules which can be used as cross-linker having a high affinity for CO₂ are commercially available. Some can be purchased from Polysciences for example.

MMMs can be produced using tri(ethylene glycol) diacrylate which is a difunctional radical cross-linker having a high affinity for CO₂. Indeed, unlike DVB, it has polar, highly reactive acrylate polymerizable groups as well as an ether-based central linkage, giving it localized polarity and polarizability to improve CO₂ solubility.

MMMs can also be produced using pentaerythritol triacrylate that is a trifunctional radical cross-linker having a high affinity for CO₂. 1,3,5-triallyl-1,3,5-triazine-2,4,6(1H,3H,5H)-trione is another example of a trifunctional organic cross-linker having a high affinity for CO₂. These two cross-linkers have 3 activated polymerizable vinyl groups per molecule, as well as polar (and polarizable) units, allowing them to form more tightly cross-linked networks at the same molar loading compared to DVB (a difunctional cross-linker).

Pentaerythritol tetra acrylate, a commercial tetrafunctional radical cross-linker, possesses similar benefits for CO₂ solubility over DVB as the other alternative cross-linkers mentioned. However, it carries 4 activated vinyl groups per molecule, allowing it to produce even more tightly cross-linked PIL networks at the same molar loading.

### 3. MMM Synthesis

Free-standing MMMs are synthesized by combining appropriate weight ratios of polymerizable IL, such as polymerizable IL monomers, IL and porous solid additive having a charged surface (such as SAPO-34).

This mixture is stirred for 24 h, followed by the addition of 0.5 to 6 wt % crosslinker (based on the IL-based components' total mass), and 0.5 to 2 wt % of a radical photo-initiator such as 2-hydroxy-2-methlpropiophenone (based on the IL-based components' total mass).

This mixture is stirred briefly before being cast onto a quartz plate treated with Rain-X™. Two 150-μm-thick glass slides are used as spacers, and a second Rain-X™_treated plate is laid on top of the mixture, producing a membrane film. The plates are clamped together and irradiated with a 365-nm UV lamp (4.3 mW/cm² at the sample surface) for 5 h at 17° C. The plates are then separated and placed in a 50° C. vacuum oven (20 torr) for 24 h.

The membrane is then peeled from one of the plates, placed in a Petri dish, and either stored under static vacuum or immediately prepared for gas permeability evaluation. A digital micrometer can be used to measure the thickness of the resulting free-standing MMM films, which usually ranged from 120 to 160 μm.

Reference MMM films are produced with DVB and MMM films of the invention are produced with crosslinkers having a high affinity for CO₂. Crosslinkers are preferably added at loading levels such that the resulting MMMs contain an equivalent number of cross-linking (i.e., activated C═C) groups.

### 2.3. Gas Permeability Measurements

The gas permeabilities of the MMM samples are measured using a custom-built apparatus equipped for high pressures and binary gas feeds using the following procedure: A circular piece of membrane is loaded into the bottom half of a steel testing cell, a rubber gasket is placed on top of it, and the top half of the cell is laid on top and secured with screws. A pair of mass flow controllers (MFCs) attached to CO₂ and CH₄ cylinders allow the feed flowrate and composition to be controlled via LabView software. The feed flowrate is orders of magnitude higher than the permeation rate, allowing the feed and retentate composition to be assumed equal.

A third MFC is used to provide a sweep stream of He to the permeate side of the membrane. Both the feed/retentate stream and the permeate stream are monitored by an in-line SRI 8610C gas chromatograph (GC) equipped with a 6-m-long Haysep D column operating at 50° C. A back-pressure regulator on the feed side is used to select the feed pressure, and digital gauges monitored the pressure on the feed and permeate streams. Permeate and retentate flowrates are determined using bubble flow meters and a stopwatch. The membrane cell rested inside a Yamato DX 300 oven to perform gas permeation measurements on the MMM samples at different elevated temperatures. The combination of GC composition data, flowrates, and pressures is used to calculate each MMM sample's CO₂ and CH₄ permeabilities, as well as CO₂/CH₄ selectivity.

Such experiment can confirm that MMMs according to the invention are designed to mitigate the issue of CO₂ plasticization and reduce swollen by CO₂ at higher pressures and temperatures. Moreover, MMMs according to the invention have high CO₂ permeability, as well as high CO₂/CH₄ selectivity.

The recitation of a listing of elements in any definition of a variable herein includes definitions of that variable as any single element or combination (or subcombination) of listed elements. The recitation of an embodiment herein includes that embodiment as any single embodiment or in combination with any other embodiments or portions thereof.

The disclosures of each and every patent, patent application, and publication cited herein are hereby incorporated herein by reference in the entireties, except for any definitions, subject matter disclaimers or disavowals, and except to the extent that the incorporated material is inconsistent with the express disclosure herein, in which case the language in this disclosure controls.

While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

1. A composition comprising:
a porous solid additive having a charged surface;
an ionic liquid;
a polymerizable ionic liquid; and
a cross-linker;
wherein the cross-linker has a high affinity to CO₂ over other light gas and comprises at least two polymerizable groups configured to react, in a radical polymerization reaction, with the polymerizable ionic liquid, said polymerizable groups containing a double bond.

2. The composition according to claim 1, wherein the cross-linker comprises a functional group having high affinity to CO₂.

3. The composition according to claim 2, wherein the functional group having high affinity to CO₂ comprise at least a functional group selected from:
phosphonium;
ammonium;
imidazolium; and
pyridinium.

4. The composition according to claim 1, wherein the cross-linker is selected from: 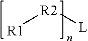
Wherein
R1 comprises a radically polymerizable double bond group;
R2 comprises a functional group having a high affinity for CO₂ over other light gases;
L refers to any carbon containing group capable of being a central point for a functional group having a high affinity for CO₂ to bond with;
n is an integer equal to or greater than 1.

5. The composition according to claim 2, wherein the functional group having high affinity to CO₂ comprise an imidazolium functional group, the cross-linker being selected from: 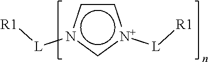
Wherein
R1 is independently selected from at least one radically polymerizable double bond group;
L is independently selected from an organyl group, a hydrocarbyl group; an alkyl group; an aliphatic group; a cycloalkyl group; an alkenyl group; an alkynyl group; an aromatic group; an aryl group; a heterocyclyl group; a cycloheteryl group; a heteroaryl group; an arylheteryl group; an organoheteryl group; an aralkyl group; a heteroaralkyl group; a halide; substituted or not;
n is an integer from 1 to 10.

6. The composition according to claim 2, wherein the functional group having high affinity to CO₂ comprise an ammonium functional group, the cross-linker being selected from:
R1-L-(AMO-L-R1)n
Wherein
R1 is independently selected from at least one radically polymerizable double bond group;
L is independently selected from an organyl group, a hydrocarbyl group; an alkyl group; an aliphatic group; a cycloalkyl group; an alkenyl group; an alkynyl group; an aromatic group; an aryl group; a heterocyclyl group; a cycloheteryl group; a heteroaryl group; an arylheteryl group; an organoheteryl group; an aralkyl group; a heteroaralkyl group; a halide; substituted or not;
AMO is independently selected from N, NR, NR₂, wherein R is a hydrogen or is independently selected from: an organyl group, a hydrocarbyl group; an alkyl group; an aliphatic group; a cycloalkyl group; an alkenyl group; an alkynyl group; an aromatic group; an aryl group; a heterocyclyl group; a cycloheteryl group; a heteroaryl group; an arylheteryl group; an organoheteryl group; an aralkyl group; a heteroaralkyl group; a halide; substituted or not;
n is an integer from 1 to 10.

7. The composition according to claim 2, wherein the functional group having high affinity to CO₂ comprise an imidazolium functional group and an ammonium functional group.

8. The composition according to claim 2, wherein the functional group having high affinity to CO₂ comprise a phosphonium functional group, the cross-linker being selected from:
R1-L-(PHOS-L-R1)n
Wherein
R1 is independently selected from at least one radically polymerizable double bond group;
L is independently selected from an organyl group, a hydrocarbyl group; an alkyl group; an aliphatic group; a cycloalkyl group; an alkenyl group; an alkynyl group; an aromatic group; an aryl group; a heterocyclyl group; a cycloheteryl group; a heteroaryl group; an arylheteryl group; an organoheteryl group; an aralkyl group; a heteroaralkyl group; a halide; substituted or not;
PHOS is independently selected from P, PR, PR₂ wherein R is a hydrogen or is independently selected from: an organyl group, a hydrocarbyl group; an alkyl group; an aliphatic group; a cycloalkyl group; an alkenyl group; an alkynyl group; an aromatic group; an aryl group; a heterocyclyl group; a cycloheteryl group; a heteroaryl group; an arylheteryl group; an organoheteryl group; an aralkyl group; a heteroaralkyl group; a halide; substituted or not; and
n is an integer from 1 to 10.

9. The composition according to claim 2, wherein the functional group having high affinity to CO₂ comprises a pyridinium functional group, the cross-linker being selected from:
R1-L-(PYR-L-R1)n
Wherein
R1 is independently selected from at least one radically polymerizable double bond group;
L is independently selected from an organyl group, a hydrocarbyl group; an alkyl group; an aliphatic group; a cycloalkyl group; an alkenyl group; an alkynyl group; an aromatic group; an aryl group; a heterocyclyl group; a cycloheteryl group; a heteroaryl group; an arylheteryl group; an organoheteryl group; an aralkyl group; a heteroaralkyl group; a halide; substituted or not;
PYR is independently selected from C₅H₅N, R-C₅H₄N, R₂C₅H₃N, R₃C₅H₂N, R₄-C₅HN, R₅C₅N, wherein R is a hydrogen or is independently selected from: an organyl group, a hydrocarbyl group; an alkyl group; an aliphatic group; a cycloalkyl group; an alkenyl group; an alkynyl group; an aromatic group; an aryl group; a heterocyclyl group; a cycloheteryl group; a heteroaryl group; an arylheteryl group; an organoheteryl group; an aralkyl group; a heteroaralkyl group; a halide; substituted or not;
n is an integer from 1 to 10.

10. The composition according to claim 1, wherein the cross-linker further comprises a polar group selected from: ether, ethylene glycol, fluoroalkyl, aromatic ring, and nitrile.

11. The composition according to claim 1, wherein the cross-linker comprises a region of overlapping p orbitals allowing a delocalization of π electrons across all adjacent p orbitals.

12. The composition according to claim 1, wherein the cross-linker comprises two radically polymerizable double bonds groups, three radically polymerizable double bonds groups or four radically polymerizable double bonds groups.

13. The composition according to claim 1, wherein the porous solid additive is selected from zeolites, metal peroxides, zeolitic imidazolate frameworks and metal organic frameworks.

14. The composition according to claim 1, wherein the ionic liquid comprises a functional group selected from:
phosphonium;
ammonium;
imidazolium; and
pyridinium.

15. The composition according to claim 1, wherein the polymerizable ionic liquid comprises a polymerizable group configured to react in a radical polymerization reaction with a polymerizable group of another polymerizable ionic liquid to form a polymer, and a group having high affinity to CO₂ over other light gas, said group having high affinity to CO₂ comprises phosphonium; ammonium; imidazolium; and/or pyridinium.

16. A mixed-matrix membrane formed from the composition of claim 1.

17. A mixed-matrix membrane comprising:
a porous solid additive having a charged surface;
an ionic liquid; and
a polymerized matrix comprising an ionic liquid polymer covalently linked with
a crosslinker;
wherein the cross linker has a high affinity to CO₂ over other light gas and the ionic liquid polymer is covalently linked with the cross-linker through a polymerizable group of the cross linker configured to react, in a radical polymerization reaction, with the ionic liquid polymer, said polymerizable groups containing double bond.

18. A method comprising separating CO₂ from a mixed gas via the mixed-matrix membrane of claim 16.

19. The method according to claim 18, wherein CO₂ is separated from the mixed gas at a pressure higher than 40 bars.

20. The method according to claim 18, wherein CO₂ is separated from the mixed gas at a temperature higher than 50° C.

21. The method according to claim 18, wherein CO₂ is separated from the mixed gas at a pressure higher than 50 bars and a temperature higher than 60° C.

22. Method of manufacturing a mixed-matrix membrane comprising a living chain-addition polymerization step based on a polymerizable ionic liquid and a cross-linker having a high affinity for CO₂ and at least two polymerizable groups configured to react, in a radical polymerization reaction, with the polymerizable ionic liquid, said polymerizable groups preferably containing double bond.
